(19) United States
(12) Patent Application Publication
(10) Pub. No.: US 2007/0198443 A1
(43) Pub. Date: Aug. 23, 2007

(54) System and method for advertising in a communication system

(76) Inventors: Sergey Chernev, Moscow (RU); Grigoriy Haldey, Moscow (RU)

Correspondence Address: Cooper & Dunham LLP, 1185 Avenue of the Americas, New York, NY, 10036, US

(21) Appl. No.: 11/648,374

(22) Filed: Dec. 28, 2006

Related U.S. Application Data
(60) Provisional application No. 60/754,819, filed on Dec. 28, 2005.
(60) Provisional application No. 60/754,746, filed on Dec. 29, 2005.
(60) Provisional application No. 60/773,270, filed on Feb. 13, 2006.
(60) Provisional application No. 60/781,978, filed on Mar. 13, 2006.
(60) Provisional application No. 60/787,800, filed on Mar. 31, 2006.
(60) Provisional application No. 60/792,717, filed on Apr. 18, 2006.
(60) Provisional application No. 60/782,131, filed on Mar. 13, 2006.
(60) Provisional application No. 60/782,132, filed on Mar. 13, 2006.

(51) Int. Cl. G06F 17/00

(52) U.S. Cl. 705/500

(57) ABSTRACT

A system for advertising in a communication system includes an advertisement device adapted to store and provide a plurality of advertisement information, a communication device and a communications provider adapted to provide communication to and from the communication device. The communication device further includes a call requesting device adapted to generate a call request for placing a call to it second communication device, a transmission device adapted to send at least the call request for placing the call to the communications provider, a receiving device for receiving it least advertisement information from the advertisement device via the communications provider, a storage device adapted to store at least the received advertisement information, an interface device adapted to present the received advertisement information to a user of the communication device. In response to the call request, the communications provider requests and receives the advertisement information from the advertisement device based on information identifying the communication device and forwards the advertisement information to the communication device.

### REFERENCE TO RELATED APPLICATION

The present application is based on and claims the benefit of U.S. Provisional Application Ser. No. 60/754,819, filed Dec. 28, 2005; U.S. Provisional Application Ser. No. 60/754,746, filed Dec. 29, 2005; U.S. Provisional Application Ser. No. 60/773,270, filed Feb. 13, 2006; U.S. Provisional Application Ser. No. 60/781,978, filed Mar. 13, 2006; U.S. Provisional Application Ser. No. 60/787,800, filed Mar. 31, 2006; U.S. Provisional Application Ser. No. 60/792,717, filed Apr. 18, 2006, U.S. Provisional Application Ser. No. 60/782,131, filed Mar. 13, 2006; and U.S. Provisional Application Ser. No. 60/782,132, filed Mar. 13, 2006, the entire contents of each of which are herein incorporated by reference.

### BACKGROUND

1. Technical Field

The present disclosure relates to advertising and, more specifically, to a system and method for advertising in a communication system.

2. Description of the Related Art

In employing conventional advertising technologies such as television and print media, products and services are often mass marketed to large groups of people who may or may not be interested in the products and services being marketed. This approach often involves great expense and wasted effort as messages are being delivered to people other than the target audience.

Moreover, attempts to mass market products and services to uninterested people run the risk of resulting in the loss of consumer good will and/or the employment of methods to avoid advertisements. For example, technologies have been developed to allow viewers to avoid ads while watching television.

Accordingly, it is desirable to utilize technology to present marketing information such as advertisements to a focused group of consumers who are believed to have an interest in the products and services being marketed. By providing this focus, advertisements may be less costly, more effective and may be better appreciated by consumers.

Methods and systems for presenting advertisements over mobile communications systems are known. For example, U.S. patent application Ser. No. 10/851,524, filed May 21, 2004 (Michael V. Papulov) and WO 2005/101864, International Filing Date Apr. 13, 2005, relate to such methods and systems. These applications are hereby incorporated by reference.

### SUMMARY

A system for advertising in a communication system includes an advertisement device adapted to store and provide a plurality of advertisement information, a communication device and a communications provider adapted to provide Communication to and from the communication device. The communication device further includes a call requesting device adapted to generate a call request for placing a call to a second communication device, a transmission device adapted to send at least the call request for placing the call to the communications provider, a receiving device for receiving at least advertisement information from the advertisement device via the communications provider, a storage device adapted to store at least the received advertisement information, an interface device adapted to present the received advertisement information to a user of the communication device. In response to the call request, the communications provider requests and receives the advertisement information from the advertisement device based on information identifying the communication device and forwards the advertisement information to the communication device.

A system for advertising in a communication system includes an advertisement device adapted to store and provide a plurality of advertisement information, a communication device and a communications provider adapted to provide Communication to and from the communication device. The communication device further includes a call requesting device adapted to generate a call request for placing a call to a second communication device, a transmission device adapted to send at least the call request for placing the call to the communications provider, a receiving device for receiving, at least advertisement information from the advertisement device via the communications provider, a storage device adapted to store at least the received advertisement information, an interface device adapted to present the received advertisement information to a user of the communication device. In response to the call request to a called communication device, the communications provider requests and receives the advertisement information from the advertisement device based on information identifying the called communication device and forwards the advertisement information to the called communication device.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram for describing an advertisement system according to embodiments of the present disclosure;

FIG. 2 is a block diagram for describing a communicating device according to embodiments of the present disclosure;

FIG. 3 is a block diagram for describing an advertising device according to embodiments of the present disclosure;

FIG. 4 is a flow chart for describing an advertising method according to an embodiment of the present disclosure;

FIG. 5 is a flow chart for describing an advertising method according to an embodiment of the present disclosure;

FIG. 6 is a flow chart for describing an advertising method according to an embodiment of the present disclosure;

FIG. 7 is a block diagram for describing a communicating device according to embodiments of the present disclosure;

FIG. 8 is a block diagram for describing a communicating device according to embodiments of the present disclosure;

FIG. 9 is a block diagram for describing a communicating device according to embodiments of the present disclosure;

FIG. 10 is a flow chart for describing an advertising system according to embodiments of the present disclosure;

FIG. 11 is flow chart for describing an advertising system according to embodiments of the present disclosure;

FIG. 12 is a block diagram of a mobile gaming system according to embodiments of the present disclosure;

FIG. 13 is a flow chart for describing an application installation procedure according to embodiments of the present disclosure;

FIG. 14 is a flow chart for describing an authorization procedure according to embodiments of the present disclosure;

FIG. 15 is a flow chart for describing a procedure for obtaining a one time access code according to embodiments of the present disclosure;

FIG. 16 is a flow chart for describing a procedure for downloading an application using a system WEB site according to embodiments of the present disclosure;

FIG. 17 is a flow chart for describing a procedure for downloading using a cell phone according to embodiments of the present disclosure;

FIG. 18 is a flow chart for describing a procedure for downloading with the help of an operator according to embodiments of the present disclosure;

FIG. 19 is a flow chart for describing a procedure for activating a link according to embodiments of the present disclosure;

FIG. 20 is a flow chart for describing a procedure for entering a WEB server according to embodiments of the present disclosure;

FIG. 21 is a flow chart for describing a procedure for performing financial transactions according to embodiments of the present disclosure;

FIG. 22 is a flow chart for describing a procedure for accessing a WAP server according to embodiments of the present disclosure; and

FIG. 23 is a now chart for describing a procedure for peer to peer cast transfers according to embodiments of the present disclosure.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

The great popularity of mobile communications devices such as mobile telephones and other connected wireless devices such as computers and PDAs equipped with mobile transmitters represents a new potential platform for the marketing of products and services. Moreover, because users of mobile communications devices tend to be registered subscribers, advertisements may be narrowly tailored for each subscriber to deliver targeted information that would tend to be effective and interesting to the user.

Methods and systems for presenting advertisements over mobile communications systems are known. For example, U.S. patent application Ser. No. 10/851,524, filed May 21, 2004 (Michael V. Papulov) and WO 2005/101864, International Filing Date Apr. 13, 2005, relate to Such methods and systems. These applications are hereby incorporated by reference.

Embodiments of the present disclosure seek to utilize new and innovative approaches to provide advertisement information to registered subscribers of mobile communications devices.

Embodiments of the present disclosure may utilize either standard mobile communications hardware, such as a user's existing mobile telephone, customized mobile communications hardware, such as a mobile telephone designed to participate in embodiments of the present disclosure, or standard mobile communications hardware that has been retrofitted with customized software and/or firmware.

According to various embodiments of the present disclosure, audio and/or graphic advertisements are displayed on a subscriber's communication device. The graphic advertisements may be still or moving advertisements and may also be referred to herein as banner advertisements.

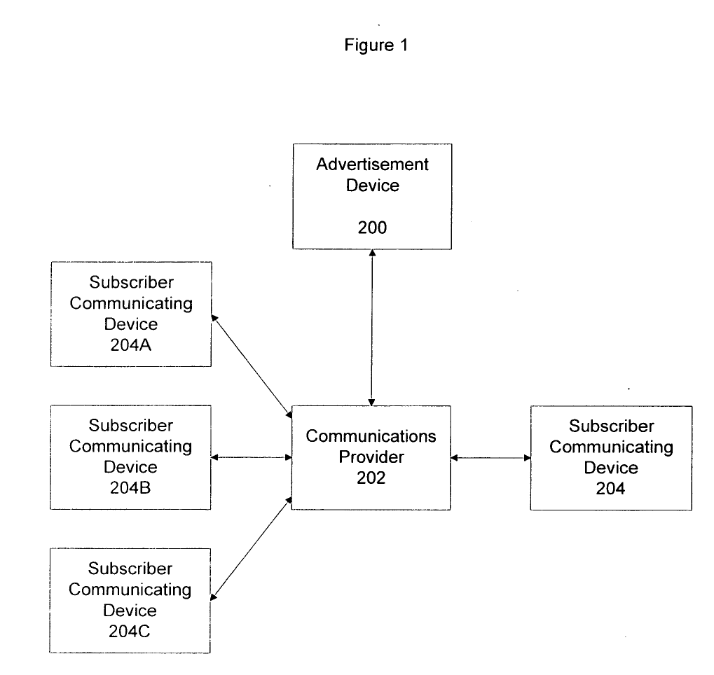

FIG. 1 illustrates a system for advertising in a communications system in accordance with an embodiment of the present disclosure. An advertisement device 200 is adapted to communicate with communications provider 202. Communications provider 202 may be, for example, an Automatic Telephone Switchboard (ATS) or operator switchboard, a wireless network, fiber optic network etc. Communications provider 202 is adapted to communicate with subscriber communicating device 204. Subscriber communicating device 204 can be any type of communication device including, for example, a mobile communication device or a land line communication device. A plurality of other subscriber communicating devices 204A-204C may also be provided. For ease of description herein, a subscriber communicating device 204 placing a call may be referred to herein as a “calling subscriber.” A subscriber communicating device 204 to which a call has been placed may be referred to herein as a “called subscriber.”

Advertisement device 200 is adapted to provide advertisements which may be stored remotely or locally with respect to the advertisement device 200. According to an embodiment of the present disclosure, when subscriber communicating device 204 places a call to another communicating device, communications provider 202 automatically notifies advertisement device 200 and provides identifying information (e.g., at least one of phone number, name, etc) identifying the calling subscriber. In response, advertisement device 200 forwards an advertisement to subscriber communicating device 204 via, for example, communications provider 202. The forwarded advertisement is then provided to the subscriber on the subscriber communicating device 204 as an audio and/or graphic (e.g., still or moving) advertisement.

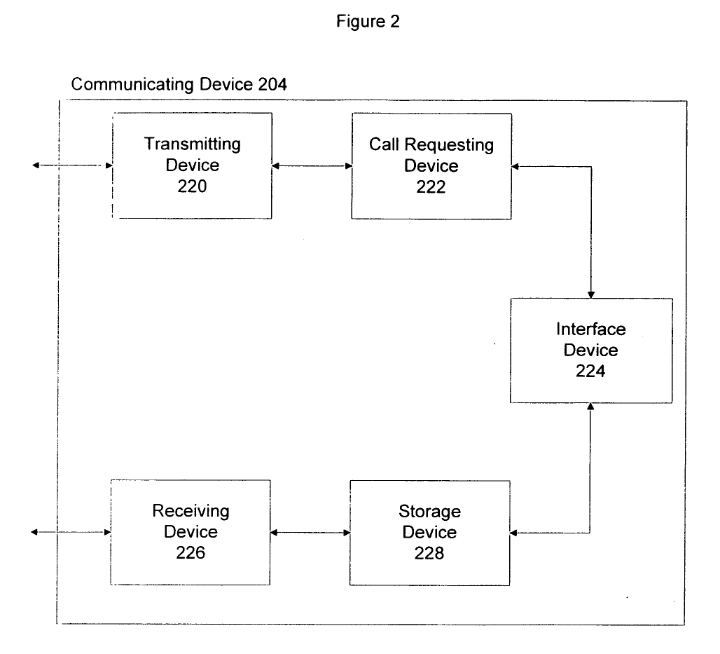

FIG. 2 illustrates in more detail a subscriber communicating device 204 according to an embodiment of the present disclosure. Subscriber communicating device 204 includes a transmitting device 220 for transmitting information to communications provider 202 and a receiving device 226 for receiving information from communications provider 202. For example, transmitting device 220 is adapted to transmit communication signals from call requesting device 222 to communications provider 202. Receiving device 226 is adapted for receiving communication signals from communications provider 202. The communication signals may include a call request, audio from a calling or called party, advertisement information from communications provider 202, etc. The communication signals may be in the form of any suitable type of communication medium depending on the type of communication technology utilized by subscriber communicating device 204. For example, the communication medium may be wired or wireless electrical signals, optical signals, etc. and will depend on the type of communication technology utilized by subscriber communicating device 204. The received advertisement information may be stored in storage device 228. The advertisement information can then be provided to the subscriber via interface device 224. For example, audio advertisement information will be presented to the subscriber through the subscriber communicating device's speaker. Picture and video advertisement information will be presented to the subscriber through the subscriber communicating device's display.

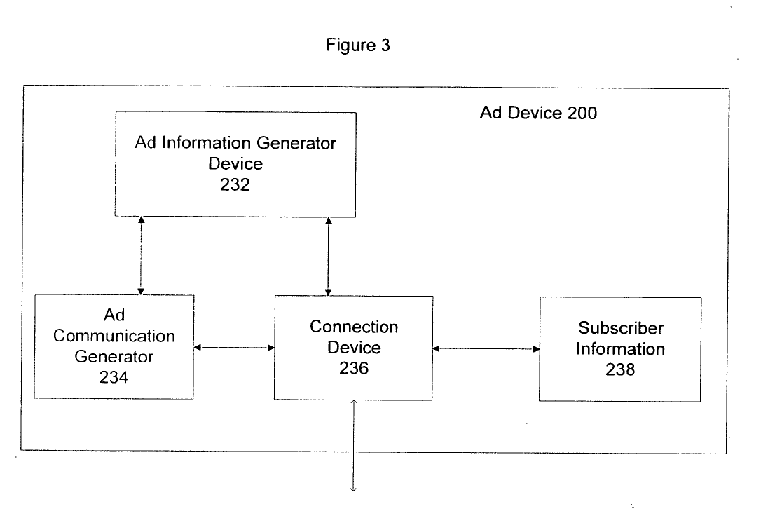

An advertisement device 200 will be described in more detail by reference to FIG. 3. Connection device 236 is adapted to communicate with communications provider 202. Connection device 236 is also adapted to communicate with ad communication generator 234, ad information generator device 232 and subscriber information device 238. Subscriber information device 238 compiles information about subscribers. For example, upon joining the advertisement system of the present disclosure, the subscriber may be required to complete a detailed survey specifying information about the subscriber. Pertinent information such as the subscriber's answers to the survey questions and information collected about the subscriber from other sources such as third party sources can then be stored by subscriber information device 238.

In addition to information collected during registration, the subscriber may be asked for information that can be used to better characterize the subscriber and better select appropriate advertisements. Information may be collected in this way, for example, periodically. That is, n addition to, or in place of the initial questionnaire, the subscriber may be presented with one or more follow-up questions or supplemental questionnaires either periodically or as desired. For example, audio questions may be presented to the subscriber in place of an advertisement and the subscriber may be asked to provide a response by the selection of an appropriate key or in another suitable manner.

Subscriber questionnaires may include one or more questions to be answered by the subscriber to obtain demographics of the subscriber. These demographics may include, for example, name, sex, date of birth, marital status, children, brand of automobile, internet usage, vacation plans, pets, telephone number, zip code or other geographic indicator, religion, household income, level of education, profession, use of cosmetics, use of household goods, use of medicine and healthcare goods, use of alcohol, use of tobacco, participation in gambling, participation in dangerous habits, licensed driver, and hobbies and/or interests, etc.

Information about the subscriber can also be gleaned from the subscriber's telephone usage. The subscriber's phone usage patterns may be analyzed and this analysis may be used as pertinent information by the advertisement system 200 and/or communications provider 202. The frequency and times of calls, duration of conversations, direction of calls, etc. may be analyzed to help identify appropriate advertisements. For example, advertisement system 200 and/or communications provider 202 may generate a user profile and compare the user profile to typical user profiles for known demographic groups. A statistical analysis may be performed at the time the advertisement server selects an advertisement, or may be periodically performed in advance.

Advertisement communication generator 234 is adapted to analyze all pertinent subscriber information and categorize subscribers into one or more target audience groups based on the subscriber information stored in subscriber information device 238. Examples of target audience groups may include restricted budget audience, business advertising, audiences for various social groupings, etc. Advertisement communication generator 234 is also adapted to maintain a list of all target audience groups to which each subscriber belongs. The list of target audience groups may be formed either periodically and/or upon input of new information so that each subscriber may be correctly categorized into one or more groups.

Advertisement information generating device 232 is adapted to store advertisement information. The advertisement information can be in the form of audio, pictorial, video, or any combination thereof. Advertisements may also be categorized by advertisement information generating device 232 according to one or more advertising groups. Examples of advertising groups may include goods for ladies, goods for men, Services, regional/local information, etc.

When a call is made using subscriber communicating device 204, connection device 236 receives identifying information identifying the calling subscriber from communications provider 202. The calling subscriber may be determined, for example, by examining the phone number from which the call was placed. Communications provider 202 may also provide other information to the advertisement device 200 such as the number the subscriber is calling, the length of calls, etc. Of course, communications provider 202 can also send the calling subscriber's phone number to connection device 236. In this situation, advertisement device 200 can determine the identity of the calling subscriber from the phone number.

Advertisement communications generator 234 is adapted to receive the calling subscriber's information from communications provider 202 via connection device 236. Advertisement communications generator 234 then determines which advertisement is appropriate for the subscriber and requests advertisement information generator device 232 to send the advertisement to communications provider 202 via connection device 236.

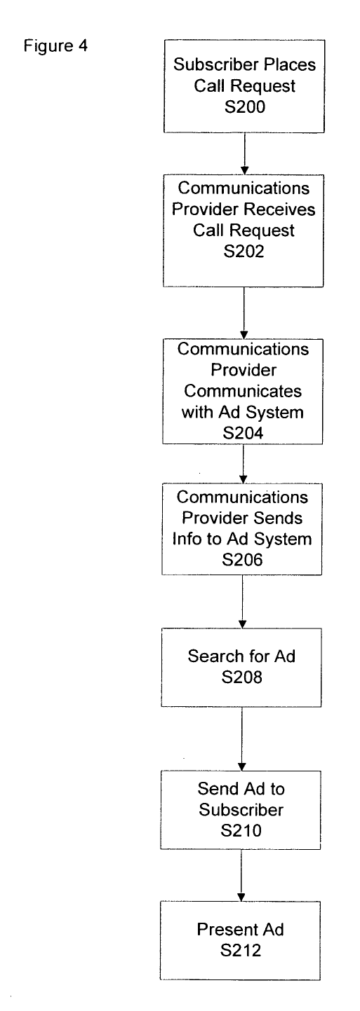

A method of advertising in a communications system according to an embodiment of the present disclosure is described with reference to FIG. 4. When a calling subscriber 204 places a request for a call (Step S200), the request gets routed to and is received by communications provider 202 (Step S202). In response, communications provider 202 routes the call request and also communicates with advertisement device 200 (Step S204). Communications provider 202 transmits information identifying the calling subscriber to advertisement device 200 and requests an advertisement (Step S206). Advertisement system 200 performs a search for an advertisement for calling subscriber 204 (Step S208). Upon selecting an advertisement, advertisement system 200 transmits the advertisement via communications provider 202 to the calling subscriber 204 (Step S210). Subscriber communicating device 204 then presents the advertisement to the subscriber (Step S212). Depending on the capabilities of the subscriber communicating device 204, the advertisement may be in audio, picture, video or a combination thereof. After the advertisement has been presented to the calling subscriber, the status of the called party (e.g., busy signal, ring tones, etc.) can be provided to the calling subscriber.

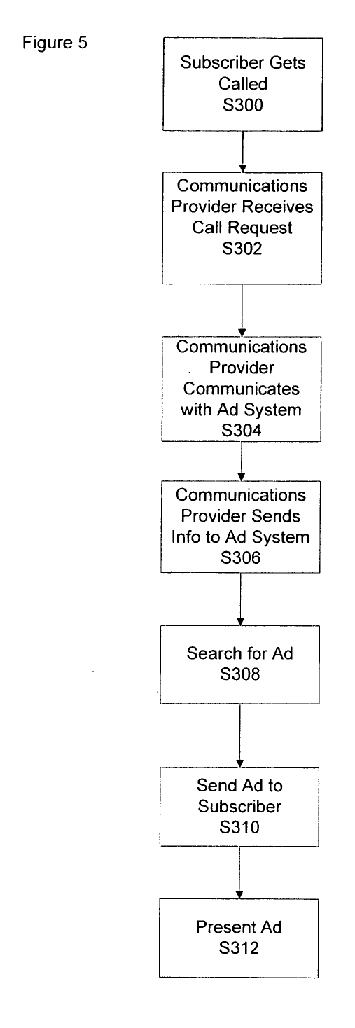

A method of advertising in a communications system according to another embodiment of the present disclosure is described with reference to FIG. 5. According to this embodiment of the present disclosure, when a called subscriber receives a call from the caller (subscriber caller or non-subscriber caller), information about the called subscriber may be used to select an appropriate advertisement to be sent to the called subscriber. When a called subscriber 204 is called (Step S300), the call request gets routed to and is received by communications provider 202 (Step S302). In response, communications provider 202 communicates with advertisement device 200 (Step S304) and transmits information identifying the called subscriber to advertisement device 200 and requests an advertisement (Step S306). Advertisement system 200 performs a search for all advertisement for called subscriber 204 (Step S308). Upon selecting an advertisement, advertisement system 200 transmits the advertisement via communications provider 202 to the called subscriber 204 (Step S310). Subscriber communicating, device 204 then presents the advertisement to the subscriber (Step S312). Depending on the capabilities of the subscriber communicating device 204, the advertisement may be in audio, picture, video or a combination thereof. The ring tone on the called subscriber's phone can occur at the same time that the advertisement occurs. For example, according to an embodiment, the ring tone can be the audio advertisement itself. According to another embodiment, a picture or video advertisement can be displayed on the phone at the same time the subscriber's phone is ringing and/or vibrating. According to yet another embodiment, the advertisement can be presented to the subscriber prior to the ring tone occurring.

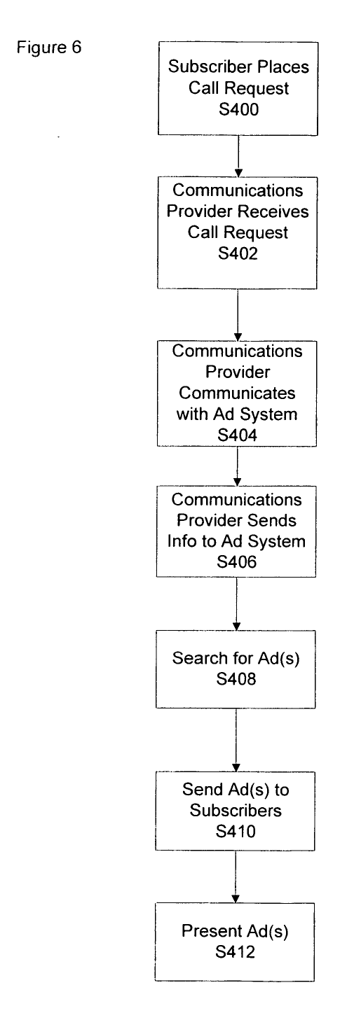

A method of advertising in a communications system according to yet another embodiment of the present disclosure is described with reference to FIG. 6. According to this embodiment, when a calling subscriber places a call to a called subscriber, information about each subscriber may be used to select a common advertisement which is sent to both subscribers or different advertisements which are sent to the subscribers. When a calling subscriber 204 places a request for a call (Step 400), the request gets routed to and is received by communications provider 202 (Step S402). In response, communications provider 202 communicates with advertisement device 200 (Step S404) and transmits information identifying the calling subscriber and the called subscriber to advertisement device 200 and requests an advertisement (Step S406). Advertisement system 200 performs a search for an advertisement for the calling and called subscribers 204 (Step S408). Upon selecting an advertisement or advertisements, advertisement system 200 transmits the advertisement(s) via communications provider 202 to the calling and called subscribers 204 (Step S410). Subscriber communicating devices 204 then present the advertisement(s) to the subscribers (Step S412).

Depending on the capabilities of the subscriber communicating devices 204, the advertisement may be in audio, picture, video or a combination thereof. After the advertisement has been presented to the calling subscriber, the status of the called party (e.g., busy signal, ring tones, etc.) can be provided to the calling subscriber. As noted above, the ring tone on the called subscriber's phone can occur at the same time that the advertisement occurs. For example, according to an embodiment, the ring tone can be the audio advertisement itself. According to another embodiment, a picture or video advertisement can be displayed on the phone at the same time the called subscriber's phone is ringing and/or vibrating. According to yet another embodiment, the advertisement can be presented to the called subscriber prior to the ring tone occurring.

Banner ads may be displayed, for example, on the display of a subscriber's communicating device as an incoming call is received, e.g., as the communicating device rings. When an incoming call is received, the subscriber will generally look at the mobile terminal in an attempt to determine the identity of the calling party and/or to answer the call. At this point, the subscriber will view the advertisement displayed on the communicating device's display. The advertisement may appear prior to the caller identification (e.g., phone number and/or name) or along with the caller identification. In this way, the subscriber's attention will be drawn to the advertisement.

The selection of banner ads may be dependent upon the limitations of the subscriber's mobile terminal. For example, if the mobile terminal has a low bandwidth data connection, leaner banner ads may be used. The limitations of the subscriber's mobile terminal can be determined when the subscriber signs up for the advertising service. For example, the subscriber may be queried regarding the make and model of their mobile terminal when signing up.

Where the mobile terminal has a color display and polyphonic audio capabilities, colored banner acts with audio may be used. The capabilities and limitations of the subscriber's mobile terminal may be discovered by the advertising service querying the subscriber's phone itself.

Subscribers may agree to receive advertisements as described above, for example, in exchange for partial or full service credit towards mobile service provision or some other method of compensation.

In tariff structures where the calling party pays for the call, embodiments of the present disclosure are effective since the calling party may be provided with the incentive of a reduced rate or free call for agreeing to hear the selected advertisement. In addition, in tariff structures where the called party pays for the call, embodiments of the present disclosure are effective since the called party may be provided with the incentive of a reduced rate or free call for agreeing to hear the selected advertisement. Of course, in tariff structures where both the calling and called parties are charged for a call, embodiments of the present disclosure may be particularly effective since both the called and calling party may be provided with the incentive.

Any of a variety of compensation scenarios may be employed to encourage a subscriber to receive advertisements according to embodiments described above. For example, the subscriber may receive a cash credit for each advertisement presented. According to another embodiment of the present disclosure, compensation may be limited to or increased in situations where both the calling subscriber and the receiving subscriber have registered to participate in the program to receive advertisements.

Compensation may be denominated in currency or credits that may be earned for each advertisement presented or for each telephone call initiated or received, that results in one or more advertisements being presented. Compensation may be independent of the length of the telephone call. For example, each call placed or received that results in presenting one or more advertisements may result in a credit of 5 cents to the participating caller or called party.

Where compensation is earned by the calling subscriber for having an ad presented on their communicating device upon initiating a call as described above, compensation may be provided to the calling subscriber regardless of whether the call is answered by the called party.

As described in the above embodiments of the present disclosure, the banner advertisements may be displayed on the mobile phone either in addition to or in place of the audio advertisements. The banner and/or audio advertisements may be sent to the subscriber communicating device over a data connection such as GPRS (General Packet Radio Services—mobile data GSM and IS-136 mobile phones) or EDVO (Evolution Data Optimized—fast wireless broadband access Internet Service for PC, phone).

Providing communicating devices with capabilities of receiving advertisements according to the various embodiments of the present disclosure as described above, may be performed in a number of ways.

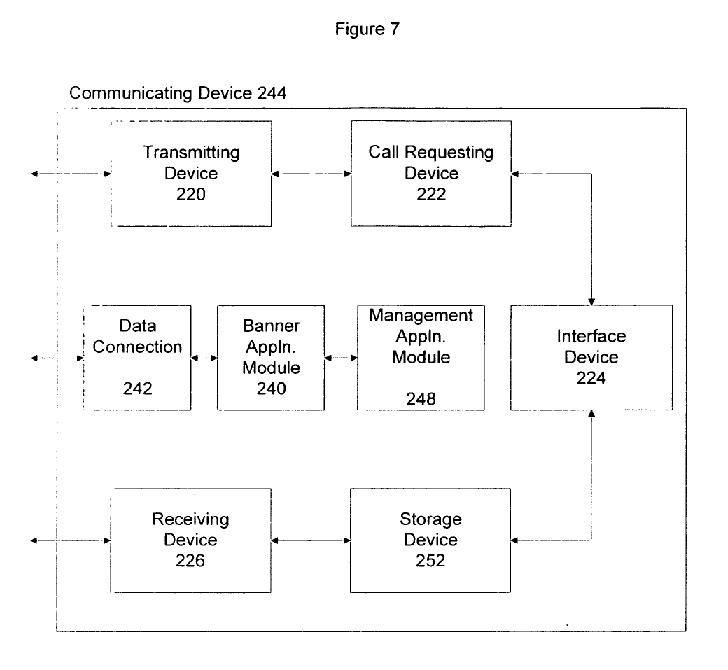

According, to an embodiment of the present disclosure as shown in FIG. 7, a communicating device 244 may be modified with one or more software application modules for receiving and displaying audio and/or banner advertisements. For example, a software banner application module 240 may be implemented on smart phones utilizing the Symbian operating system. Other possible platforms include Windows Mobile, Palm OS, Blackberry, Sidekick or any other suitable platform. The software banner application module 204 may be loaded by a technician when the phone and/or advertising service is sold to the subscriber. In the alternative, software banner application module 240 can be downloaded to the subscriber's mobile unit by the subscriber himself when signing up for the advertising service on a website over the internet. The download can be via a wireless or wired connection. For example, a subscriber may call a registration phone number, send a text message or email to a registration server associated with advertisement device 200 requesting to download software banner application module 240. The text message, call or email may provide information to the registration server associated with the advertisement device 200 that allows for the personalization of the application. For example, the subscriber may include in the text message information pertaining to the subscriber's telephone model, type of service, etc.

The registration server may then transmit the banner software application module 240 directly to the subscriber communicating device 244 over a data connection 242 or transmit a link that would allow the subscriber to download the appropriate software application over the data network. Subscriber communicating devices according to various embodiments of the present disclosure, may be provided with wireless application protocol browsers (WAP browsers). WAP browsers allow access to the Internet from a mobile communication device. The link allowing the subscriber to download the appropriate software application over the data network may be to a WAP site which is a website written in, or dynamically converted to a wireless markup language (WML). The link may be, for example, a link to a WAP page on the Internet that is linked to the transmission of an application file that has been personalized for the particular subscriber. After the file(s) has been received by the subscriber communicating device, the file may be executed and the application installed by the subscriber.

In addition to providing for the presentation of banner ads, a software management application module 248 executable on the communicating device 244 may be utilized to manage and administer the subscriber's advertisement program account. In this way, relevant information can be stored on the subscriber communicating device allowing the subscriber to view the information as desired. According to an embodiment of the present disclosure, the software management application module can keep track of the history of the payments entered for the incoming calls with advertisements. The advertising banners that have been sent to the communicating device can also be stored on the communicating device in storage device 252 for later viewing by the subscriber. The software management application module 248 may also be installed on the subscriber's mobile device either at an authorized service center, by transfer from a desktop computer, or by transmission over a data service directly to the communicating device 244.

According to an embodiment of the present disclosure, the first time the subscriber executes the banner application module 240 or the management application module 248, the subscriber may be presented with a terms of service agreement that the Subscriber should agree to in order to participate in the advertising/compensation system. The Subscriber may also be presented at this time with a questionnaire used to supply the advertisement system with pertinent information for the selection of advertisements.

According to another embodiment of the present disclosure, subscribers to a service can effectively rent ad space on their communication device screens. According to this embodiment, a subscriber's communication device includes a module that periodically gets new ads from an ad server and displays them on the subscriber's communication device. For example, the ads can be displayed on the entire screen or on a portion of the device's screen not used for phone operation information. According to an embodiment of the present disclosure, the module periodically sends information to the ad server indicating the amount of time the ads were displayed on the subscribers communication device so that the subscriber can be compensated.

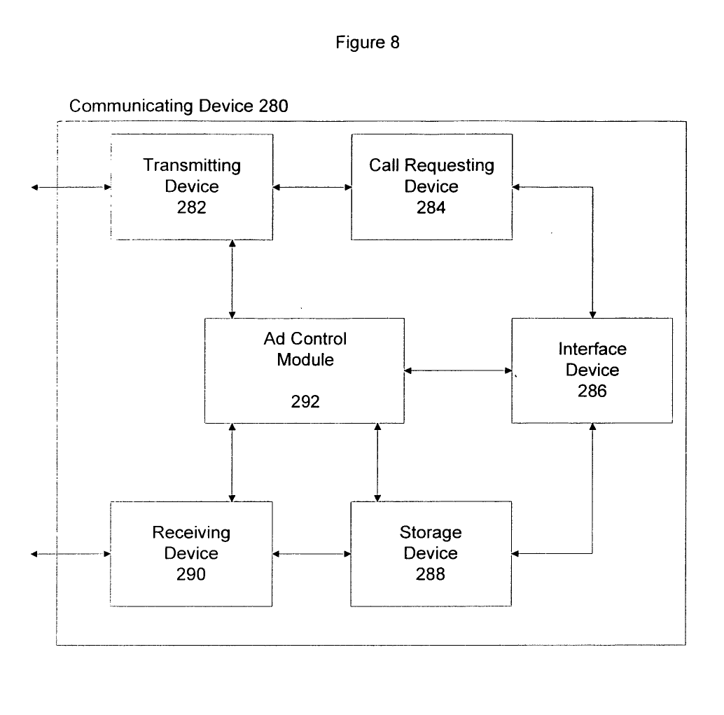

A subscriber communication device according to an embodiment of the present disclosure is shown in FIG. 8. Subscriber communication device 280 includes a transmitting device 282, call request device 284, interface device 286, storage device 288 and receiving device 290 which are functionally similar to those correspondingly named devices shown in FIG. 2. Ad control module 292 is responsible for periodically requesting ads from an advertisement system. For example, according to an embodiment of the present disclosure, using transmitting device 282, ad control module 292 automatically periodically sends a request for an ad update to an advertisement device 200 via communications provider 202 (FIG. 1). The request may include information identifying the subscriber communicating device, allowing advertisement device 200 to choose one or more ads targeted for this particular subscriber. The request may also include updated information indicating the subscriber's phone usage habits, type of phone, etc. which can be saved by the advertisement device 200 and used to further target ads for the subscriber.

After an ad is selected, the ad is automatically sent to the subscriber communication device 280 via communications provider 202 and is received by receiving device 290. The ad can then be stored in storage device 288 and presented to the subscriber by ad control module 292 via interface device 286. The ad may be in the form of a picture or video that is displayed on the communicating devices screen. According to another embodiment of the present disclosure, the ad is an audio clip, for example, a product jingle that serves as the communicating devices ring tone.

According to another embodiment of the present disclosure, instead of the subscriber's communication device requesting an ad update, the advertisement device 200 periodically sends automatic ad updates to the subscribers communicating device. Ad control module 292 receives the ads and stores the ads in storage device 288. Ad control module 292 then presents the ads to the subscriber via audio and/or visual systems provided on the subscriber's communicating device.

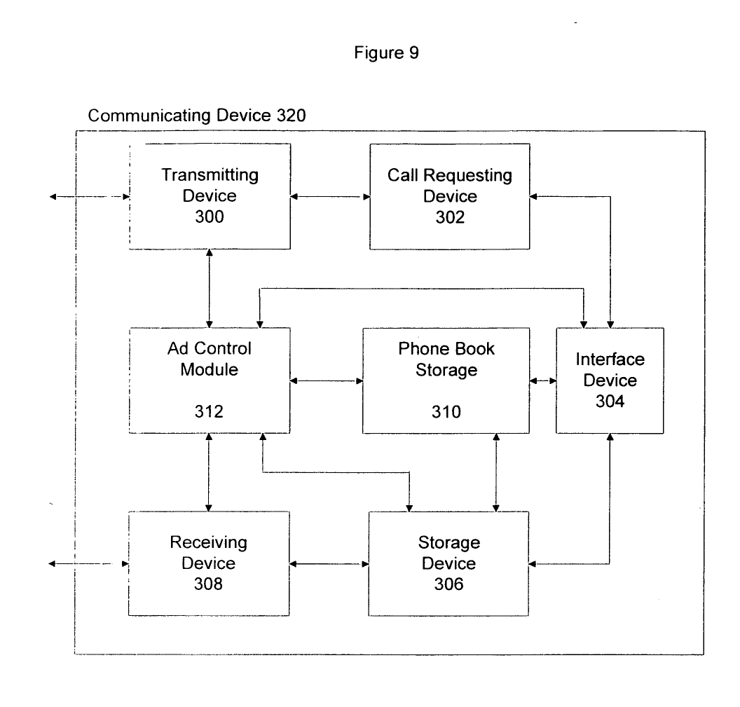

Most modern communicating devices have an integrated phone book feature that allows contacts, generally including names or descriptions and telephone numbers to be preprogramed into the device for fast recall and easy dialing. A communicating device 320 according to an embodiment of the present disclosure is shown in FIG. 9.

In addition to including phone book storage 310, the communicating device 320 includes transmitting device 300, call requesting device 302, interface device 304, storage device 306 and receiving device 308 which operate in the same manner as similarly named devices described in previous embodiments. However, according to this embodiment of the present disclosure, the phone book storage 310 of the subscriber's communicating device 320 is automatically populated with entries including the phone numbers and descriptions of businesses offering goods and/or services that may be of interest to the subscriber. Although phone book storage 310 is shown separate from storage device 306, it should be appreciated that phone book storage 310 and storage device 306 my share common memory space and/or controllers

The business information populating the phone book storage 310 may include, for example those businesses whose ads are presented to the subscriber. The same systems or systems similar to those described above used for serving advertisements to subscribers may be used to populate the subscriber's communicating device 320. The phone book storage 310 may be populated by an ad control module 312 similar to the module 292 described in FIG. 8. According to an embodiment of the present disclosure, the phone book storage 310 may be a pre-populated with phone numbers and descriptions of businesses offering goods and/or services when the subscriber first receives the communicating, device.

The phone book storage 310 may be populated via a data connection as described above in earlier-described embodiments and/or by wired interface to the communicating device at a service center.

As most modern mobile communicating devices can have as many as 500 or more available entries for contacts in the phone book, as many as 200 to 300 entries may be populated by participating businesses. The population of the subscriber's mobile communicating device phone book may be a precondition to participation in the program or may be an option that allows the subscriber to earn additional compensation.

The population of the subscriber's mobile communicating device phone book may be designed to allow the subscriber to more easily contact a business whose ad the subscriber encountered as part of the present disclosure and/or the phone book entries may be unrelated. According to an embodiment of the present disclosure, the subscriber can be prompted to determine whether he wants to save the ads contact information in the phone book.

Selection of which listings to place in the subscriber's mobile communicating device phone book may be based on the pertinent information relating to the subscriber. For example, listings for a local pizza delivery company and/or a local taxi cab company may be selected based on the subscriber's location and/or area code.

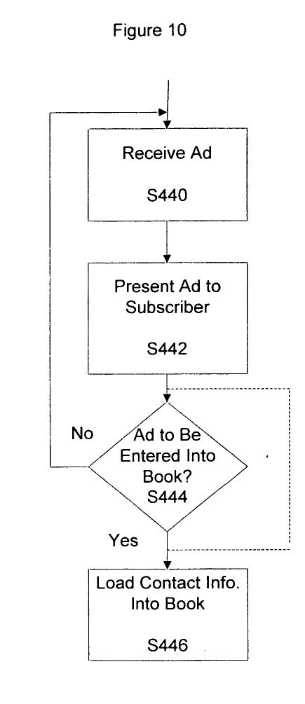

An example of storing ads in a mobile communicating device phone book according to an embodiment of the present disclosure will now be described by reference to FIG. 10. Ads are received (Step S440) utilizing one or more embodiments of the present disclosure described herein. The ads are then presented to the subscriber via the mobile communicating devices audio and/or visual systems (Step S442). It is then determined whether the contact information corresponding to the ad is to be saved in the subscriber terminal's phone book storage (Step S444). As noted above, this decision may be made by the subscriber terminal 320 and/or ad control module 312 (FIG. 9). If the ad is for a business located in the same (or near) area code as the subscriber, the information is automatically saved to the phone book. In addition or as an alternative, the subscriber can be prompted to determine whether the contact information should be saved in the phone book. As shown by dashed lines in FIG. 10, in an alternative embodiment Step S444 can be omitted and the contact information can automatically be entered into the phone book (Step S446).

It has become quite common for subscribers to purchase various extras such as custom ring tones, screen savers, audio files such as music, video files such as television programs and movies, background pictures, video games or programs that may be broadcast over the mobile network. The sale of such extras may be incorporated into embodiments of the present disclosure by allowing subscribers to use compensation accumulated by viewing advertisements to purchase such extras either directly through the advertisement service provider or through third parties. Moreover, advertisement based extras such as ring tones with corporate slogans or jingles may be obtained, for example without charge and/or for the further accumulation of compensation.

Embodiments of the present disclosure may provide an enhanced system for allowing subscribers to easily receive additional information and/or purchase goods and services that are advertised as part of the present disclosure.

For example, banner ads displayed in the manner described above may include a hyperlink to an advertiser's WAP page. The WAP page may include additional information about the goods or services marketed in the displayed ads and/or ordering instructions.

According to an embodiment of the present disclosure, an audio advertisement may include a telephone number that may be called to receive additional information and/or to place an order. Alternatively, the subscriber may be prompted to press a key to receive more information or to place an order and after the call has been completed, the subscriber may be connected to an automated or staffed call center.

According to an embodiment, accumulated compensation may used to pay for or defray mobile provider service charges and/or towards the purchase of new hardware. Accumulated compensation may also be used towards the purchase of ring tones and extras as described above. Subscribers may also be provided the option to redeem accumulated compensation and/or gaming winnings (where implemented) by bank transfer or some other means of pecuniary transfer. Accumulated compensation may also be used to pay for mobile services such as financial news services, sports news services, etc.

The accounting of accumulated compensation may be incorporated into a virtual wallet application that allows the subscriber to purchase goods and services and make payments, for example, by transferring money between participating subscribers. Accordingly, funds may be transferred into a virtual wallet by credit card or bank transfer and easily used for the purchase of goods and services, for example, those services promoted by the advertisements. The virtual wallet operation may be handled by an accounting server and/or handled by a third party partner with an existing virtual wallet and/or money transfer service.

As discussed above, compensation is accumulated by the viewing of advertisements and/or the receiving/placing of calls that are associated with advertisements. An accurate accounting of the subscriber's viewing history may be achieved by the recording of advertisement viewing statistics either at the mobile terminal side or the advertisement server side.

These statistics may also be used to indicate when an advertisement has been viewed up to a predetermined maximum number of times. An advertisement viewed the maximum number of times may be flagged for replacement and subsequently replaced with another advertisement by the advertisement device. Advertisement replacement and/or updating may occur as needed or periodically, for example, at times of off-peak network usage and when the mobile terminal is not otherwise in use.

Statistics relating to the subscriber's mobile terminal usage and advertisement viewing may be relayed to participating businesses so that advertisements may be tailored for maximum effectiveness.

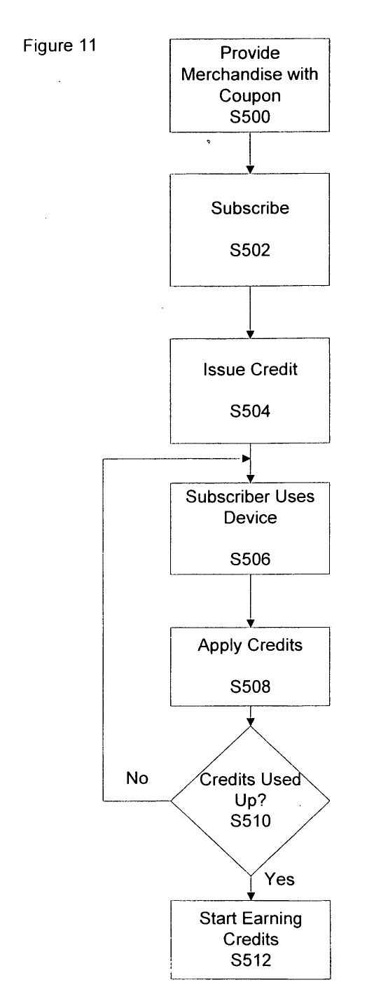

According to another embodiment of the present disclosure, a subscriber is given a set amount of credit for subscribing to an advertisement system as described above and for using it for a period of time. After that time is up, the subscriber will receive credit/compensation as ads are presented on the subscriber's communicating device. This may be implemented in a number of ways. For example, according to an embodiment of the present disclosure as shown in FIG. 11, merchandise can include a coupon (Step S500) with information describing aspects of a communication device and ad system with advertising as described in one or more of the above-described embodiments. The coupon may include an offer that upon subscribing to an ad system, the subscriber will receive a certain amount of credits (possibly up to the value of the merchandise itself) on their communication device account. When a person subscribes to the ad system and obtains a communication device (free or purchased), the subscriber is issued a set amount of credit (Step S504). To ensure loyalty, only a portion of the credits can be applied towards the subscriber's communication bill per month. That is, as the subscriber uses the communication device (Step S506) and is presented with ads, the subscriber can then apply a portion of those credits towards their monthly bill (Step S508). When the user's credits have been used up (Yes, Step S510), the subscriber can start earning credits as described in one or more of the above-described embodiments.

Embodiments of the present disclosure may be combined with approaches to mobile terminal gaming and wagering. For example, advertisements may relate to mobile terminal gaming and wagering services that are provided by the same system as the present disclosure and/or a third party. According to one embodiment, earned compensation may be wagered in a game of chance. Winnings resulting from the games of chance may be added to the subscriber's accumulated compensation. A mobile terminal game can be, for example, a lottery type game in which the user accesses winning numbers via their mobile phone.

Mobile gaming systems present problems relating to security. For example, a reliable user authorization system would be desirable for implementing a practical mobile gaming system. A reliable user authorization system would enable the automation of most of the operations in a mobile gaming system involving user identification and account activities. A reliable user authorization system should be as easy and transparent as possible to use, and, at the same time, provide the required level of confidentiality and protection.

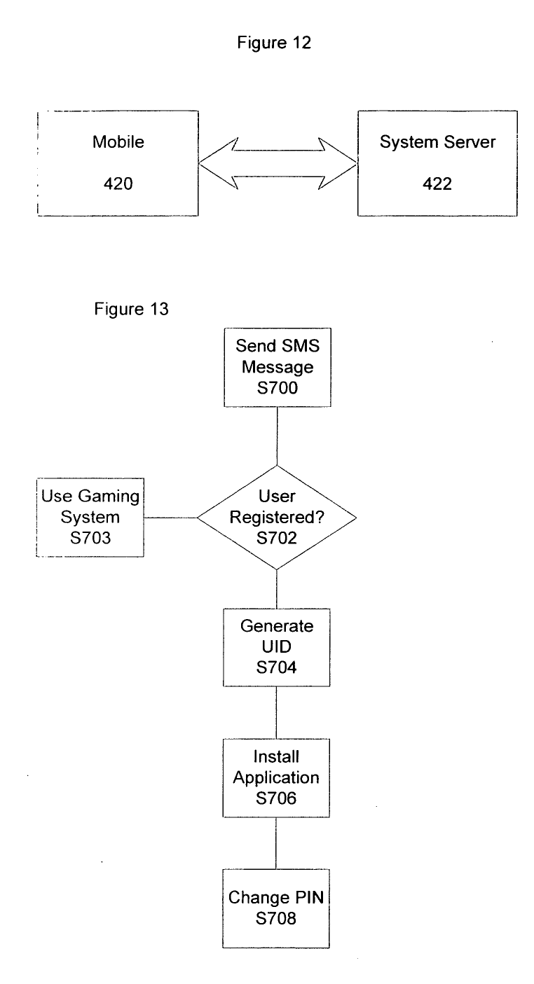

A mobile gaming system according to an embodiment of the present disclosure is shown in FIG. 12 and involves communication between programs on the user's mobile terminal 420 (e.g., a Global System for Mobil Communications (GSM) telephone) and a system applications server 422 using existing data transmission technologies such as the GSM and the Internet environments.

Registering in the mobile gaming system will now be described by reference to FIG. 13. To register in the system, the user sends an SMS message from their mobile terminal 420 to a number associated with system server 422 which can be specified during registration (e.g., at the system site, on advertising posters or brochures, etc.) (Step S700). The message contain a game application code appropriate for the model of the user's telephone.

If the user is registered in the system (Yes, Step S702), the user proceeds to use the gaming system. If the user in question is not registered in the system (No, Step S702) (e.g., verified from calling telephone number of mobile terminal 420), the system generates a new Unique User Identifier (UID) and sends a link for downloading a personalized application (Step S704). Each mobile application, regardless of the type or model of the telephone used, contains a main menu item MOBILE GAMING, which enables access to the user's account-management features (hereinafter referred to as the MOBILE GAMING menu item). This function is subsequently employed by the user to carry out most of the operations involving his account.

The user follows the link indicated in the SMS message sent and downloads and installs the mobile game application (Step S706). The application downloaded by the user is identified by the registered Application Serial Number (ASN) and UID of the user.

With the initial startup of the installed game application, if the user has not started other installed applications of that service, the application prompts the user to set (change) his PIN for access (Step S708). The user's PIN should be at least 4 characters in length (maximum length, 8 characters). To perform this operation, the user should enter the new PIN twice, so as to avoid error. After the PIN code is changed, the user is a registered participant in the Mobile Gaming System.

A menu function, which is in all mobile applications (and may also be implemented as a special link on WAP sites of the system) in the mobile game system and employs the described features for providing security, is used to perform various functions. For example, the user can change the user's PIN code, perform user account operations (deposit cash or withdraw funds from the user's account at the system's payment centers), making requests to upgrade game applications for mobile telephones and receive short-term, one-time authorization keys for accessing the system's WEB and WAP resources and other services

All communications between the mobile game application and the system applications server are effected via a secure SSL protocol (HTTPS, WTLS) or a protocol of equivalent cryptographic security (external RSA and IDEA encryption libraries are used for MIDP 1.0 devices and some MIDP 2.0 models that do not support the HTTPS protocol or erroneously implement that protocol).

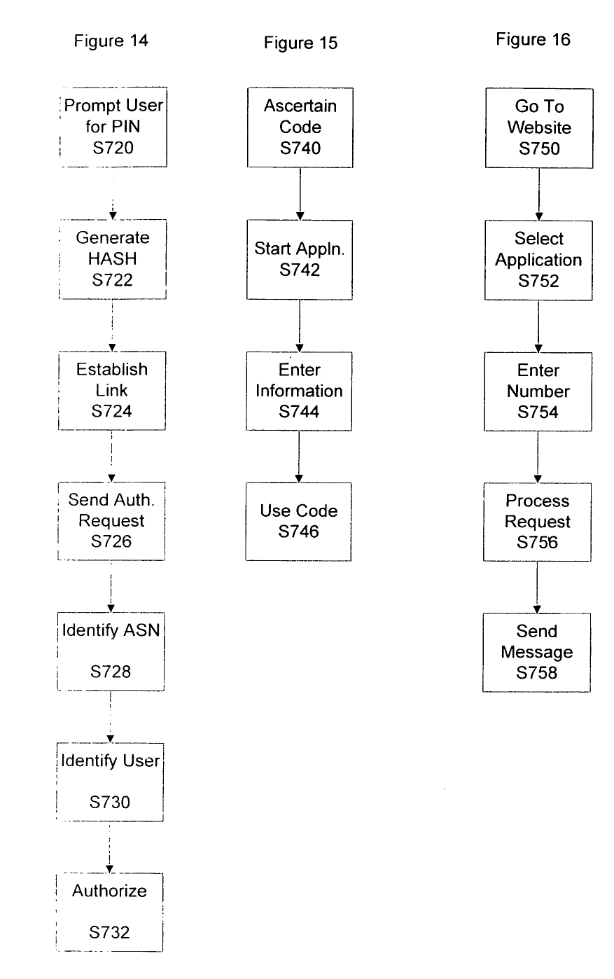

According to an embodiment of the present disclosure, the user goes through an authorization procedure to carry out most actions in the Mobile Game System. The authorization procedure, according to an embodiment of the present disclosure is shown in FIG. 14. The application prompts the user for the PIN (Step S720). A UIDhash is then generated on the basis of the PIN and the UID registered in the application (Step S722). A secure link (RSA, IDEA, or HTTPS) is established with the server (Step S724). The mobile application then sends an authorization request containing the ASN and UIDhash (Step S726). The server then identifies the ASN and checks to see if it has been blocked (Step S728). If the ASN has been blocked, a message is sent to the user asking him to download a new copy of the application. The server then identifies the user from the ASN and checks the UIDhash (Step S730). If the UIDhash matches, a positive authorization result is sent (Step S732).

When any operation is being carried out, if the user enters an incorrect PIN three times (this is checked at the system server 422 by comparing a stored UIDhash value against a value computed from the PIN and sent to the system server 422), the user's account is blocked for 24 hours (this period may be adjusted using the system's administrative interface). This mechanism is used to provide protection against someone gaining unauthorized access to the user's account by the direct method of trying PIN numbers if a telephone is stolen or lost.

Embodiments of the present disclosure thus provide various levels of protection including HTTPS which protects against interception of Internet traffic and a unique UID number which identifies the user in the system. The protection also includes an ASN used to identify the application and user and a PIN code used to compute the hash function from the UID for authorization on the system server.

According, to an embodiment of the present disclosure as shown in FIG. 15, the user can obtain a short-term, one-time access code by using a service identifier (Gate ID). The user ascertains the code of the required service (at the system WEB site, from advertising or distributed material, etc.) (Step S740). The use then starts the application containing the MOBILE GAMING features and selects the menu item MOBILE GAMING (Step S742). In the dialog box that appears, the user enters the service number (Gate ID) and his PIN code (optional, depending on whether the PIN code was entered when the application was started), as well as the operation parameter if the selected Gate ID includes such a parameter Step S744). Depending on the type of service, the access code is shown on the screen or is sent by SMS (typically, only a URL for access to various types of resources and service, but not secret access keys, can be sent by SMS). The user may then use the access code generated for authorization in the services of the Mobile Game Project (Step S746).

The access code (authorization) the user receives is linked to the particular user and is a short-lived key (several minutes) of 8-12 characters. The time it takes to go through the combinations in order to hack into the service may be further slowed by introducing an artificial delay of several hundred milliseconds at the server end during operations involving the use of the access code.

To download a mobile game application, the subscriber should first obtain a link for carrying out the operation. The link is sent to the subscriber in an SMS message. There are various ways this can be performed.

According to an embodiment of the present disclosure, the application can be downloaded using the system's public WEB site. As shown in FIG. 16, the subscriber goes to the system's public site (Step S750). The subscriber then selects the required mobile application based on the model of his cell phone (Step S752). The subscriber then enters his mobile telephone number and initiates the operation to obtain the link for downloading the mobile application (Step S754). The server then processes the request (Step S756), creating an account for the subscriber if the subscriber is a first-time user of the service (which is determined from his telephone number). The server then sends a message containing the link to download the application (Step S758).

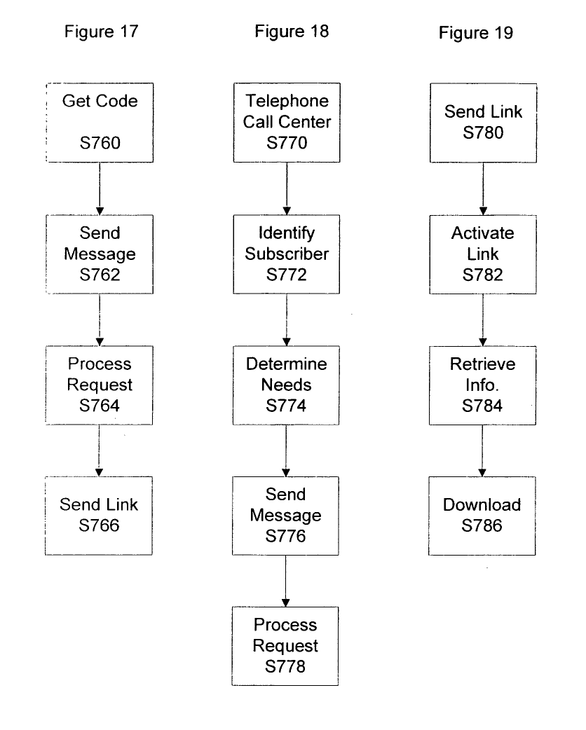

According to another embodiment of the present disclosure, the application can be downloaded using a cell phone. As shown in FIG. 17, the subscriber ascertains the code for downloading the required application (from advertising or other sources external to the system) (Step S760). The subscriber then sends a message with the application code to the service number (Step S762). The server processes the request (Step S764), creating an account for the subscriber if the subscriber is a first-time user of the service (which is determined from his telephone number). The server then sends a message containing, the link to download the application (Step S766).

According to another embodiment of the present disclosure, the application can be downloaded with the help of an operator. As shown in FIG. 18, the subscriber telephones the call center number from his cell phone (Step S770). The subscriber is identified in the system from the telephone number from which he calls (Step S772), and, if necessary, a new user account is created. The operator determines the subscriber's needs, including the model of his cell phone and the game application the subscriber wishes to download (Step S774). The operator initiates the process of sending the subscriber a message containing the URL for downloading the application (Step S776). The server then processes the request and sends an SMS message with the link for the subscriber to download the application (Step S778).

As shown in FIG. 19, after the link is sent and received using one of the above-described methods (Step S780), the subscriber activates the link (Step S782). This launches the telephone's built-in WAP browser, and the system's WAP server is accessed. Using the operation code registered in the URL link that was sent, the system server retrieves the information on the request to download the application, prepares the application (assembling and signing a Midlet of the application selected, assigns an ASN to the new application, and blocks all old applications of that type) (Step S784). As a result, the subscriber downloads and installs the application to his cell phone (Step S786).

To upgrade game applications, the user starts the mobile game application and, alter authorization, selects the MOBILE GAMING menu option for upgrading applications. After the request arrives, the server determines the type of application and the telephone model from the ASN of the application from which the request was sent. If any upgrades for the telephone model and the type of application are installed on the server, the operation of downloading a new copy of the upgraded application is registered, and the subscriber is sent an SMS message with a download code. The download then proceeds using one of the methods described above.

After starting the application, the user enters his PIN code. The application sends the UIDhash value computed from the UID and PIN to the game server. If the computed UIDhash value matches, the user is authorized on the server, and a user session is initiated.

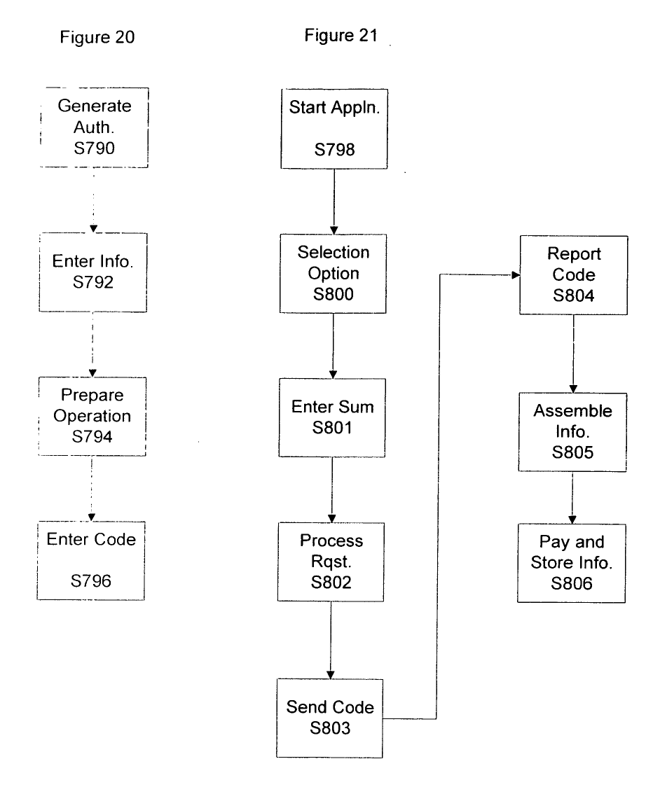

As shown in FIG. 20, to enter the mobile game system's WEB server, the user generates all authorization key by using the mobile game application installed on his telephone (Step S790). After starting the application, the user selects the MOBILE GAMING option, enters the Gate ID for the operation of entering the server (shown on the authorization page of the web server), and sends a request for an authorization code (Step S792). The system server prepares the operation and returns the code for performing it to the application on the subscriber telephone (Step S794). The user enters the code he has received into the field for the authorization code on the WEB server, and the WEB server verifies the entered code, retrieves the information on the subscriber, and initiates a session with personalized access to the server (Step S796).

According to embodiments of the present disclosure, in addition to or as an alternative of using compensation earned from viewing ads, the user can perform financial transactions to add money to their gaming account. As shown in FIG. 21, the user starts the application mobile game application and gains authorization with his PIN code (Step S790). The user then selects the MOBILE GAMING menu option and makes his request, entering the Gate ID for the operation to be performed (depositing money into or withdrawing money from his game account at the appropriate cash reception/payment office) (Step S792). The user then enters the required sum as a request parameter (Step S794). The system then processes the request and prepares the operation on the server (Step S796). The code for performing the operation is then sent to the user (Step S798). The user reports the code to the cashier, who enters the operation code at the cash terminal interface (Step S800). Based on the operation code, the financial system assembles all the information on the operation (including the sum and the direction of the operation) (Step S802). The cashier pays out or receives the money and confirms completion of the operation on the server. The server stores the operation code, the direction of the payment, the amount of the payment, and the identification number of the service center (Step S804). The client writes an anonymous receipt containing at least 20 characters and indicating receipt of the indicated amount. The receipt can be kept by the cashier to enable examination by a handwriting expert in the event that a dispute should arise.

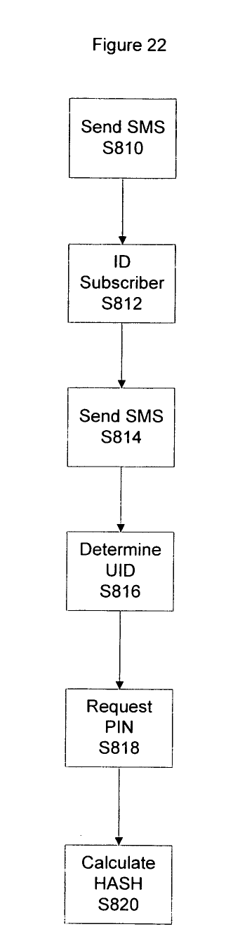

As shown in FIG. 22, for access to the WAP server of the mobile game system or game service, the subscriber sends an SMS message to the number of the service (Step S810). Upon receipt of the message, the system identifies the subscriber from his telephone number and prepares the information on the subscriber (if the subscriber is a first-time user of the services, a new subscriber account is created in the system) (Step S812). In response to the message sent, the subscriber is sent an SMS message that contains the URL for access to the system and in which the operation access code is encoded (Step S814). After the connection is activated using the telephone's WAP browser, the server determines the subscriber's UID identifier from the operation access code (Step S816). Communication with the user is effected via HTTPS/WTLS protocols. If the subscriber's telephone does not support WAP communication using secure protocols, then this scenario becomes inaccessible to the subscriber, since, in this case, there is no technological capability for protecting data from interception by third parties when the data are sent via open HTTP/WTLS protocols. Once a secure connection has been made, the server requests the subscriber's PIN code (if the subscriber is a first-time user of the services, the server prompts the subscriber to initialize his PIN code by entering it twice) (Step S818). Once the PIN code has been received by the server, the hash function is calculated from the UID (which is stored on the server), and the user is authorized in the system (Step S820). If the PIN is repeatedly entered incorrectly, the subscriber account is blocked in the system.

The MOBILE GAMING functions described above may be implemented as WAP site functions, in which case the subscriber has access to the same range of operations that is available when mobile applications installed to the telephone are used.

Mobile terminals may also be effectively and safely used for peer to peer (P2P) cash transfers. For example, according to an embodiment of the present disclosure, cash can be sent from any phone (or personal computer (PC)) and/or to any phone (or PC). P2P technology allows phones and/or PCs to directly connect with each other, bypassing the central computers that normally serve up Web pages. As P2P computing evolves, the sharing of computer resources and services by direct exchange between systems becomes more frequent. These resources and services include exchanging information, processing cycles, cache storage, and disk storage for files. Peer-to-peer computing takes advantage of existing desktop computing power and networking connectivity. An Intelligent Cash Unit (ICU) eWallet is funded like other debit card systems such as PayPal, Neteller, etc.

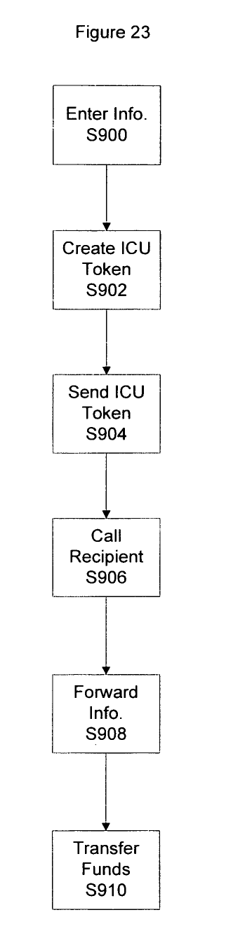

According to an embodiment of the present disclosure as shown in FIG. 23, a sender enters via a communication device (PC or phone) an amount to send and the recipient's cellphone number (Step S900). An ICU token is then created with the information (Step S902). The ICU token is then sent via SMS to the recipient (Step S904) and the sender calls the recipient with a 4 digit PIN (Step S906). The recipient then forwards the SMS with the ICU to an authorized agent (e.g., the cellphone provider) and enters the 4 digit PIN provided by the sender (Step S908). The senders bank account is debited and the recipient's bank account is credited within 24 hours (Step S910) by a SWIFT banking request.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

1. A system for advertising in a communication system comprising:
an advertisement device adapted to store and provide a plurality of advertisement information;
a communication device; and
at communications provider adapted to provide communication to and from the communication device,
wherein the communication device further comprises: a call requesting device adapted to generate a call request for placing a call to a second communication device; a transmission device adapted to send at least the call request for placing the call to the communications provider; a receiving device for receiving at least advertisement information from the advertisement device via the communications provider; a storage device adapted to store at least the received advertisement information; an interface device adapted to present the received advertisement information to a user of the communication device, wherein in response to the call request, the communications provider requests and receives the advertisement information from the advertisement device based on information identifying the communication device and forwards the advertisement information to the communication device.

2. The system of claim 1, wherein the plurality of advertisement information stored in the advertisement device comprise at least one of audio and visual advertisement information.

3. The system of claim 2, wherein the advertisement device further comprises a device adapted for storing subscriber information.

4. The system of claim 3, wherein the advertisement device selects advertisement information based on the stored subscriber information.

5. The system of claim 1, wherein the information identifying the communication device comprises a phone number associated with the communication device.

6-19. (canceled)

20. A system for advertising in a communication system comprising:
an advertisement device adapted to store and provide a plurality of advertisement information;
a communication device; and
a communications provider adapted to provide communication to and from the communication device,
wherein the communication device further comprises: a call requesting device adapted to generate a call request for placing a call to a second communication device; a transmission device adapted to send at least the call request for placing the call to the communications provider; a receiving device for receiving at least advertisement information from the advertisement device via the communications provider; a storage device adapted to store at least the received advertisement information; an interface device adapted to present the received advertisement information to a user of the communication device, wherein in response to the call request to a called communication device, the communications provider requests and receives the advertisement information from the advertisement device based on information identifying the called communication device and forwards the advertisement information to the called communication device.

21. The system of claim 20, wherein the plurality of advertisement information stored in the advertisement device comprise at least one of audio and visual advertisement information.

22. The system of claim 21, wherein the advertisement device further comprises a device adapted for storing subscriber information.

23. The system of claim 22, wherein the advertisement device selects advertisement information based on the stored subscriber information.

24. The system of claim 21, wherein the information identifying the called communication device comprises a phone number associated with the mobile communication device.

25. The system of claim 22, wherein the subscriber information comprises information relating to capabilities of the called communication device.

26-38. (canceled)

39. A method for advertising in a communication system comprising:
generating a call request using a calling communication device for placing a call to a called communication device;
sending at least the call request for placing the call to a communications provider;
receiving at least advertisement information from an advertisement device via the communications provider;
storing at least the received advertisement information; and
presenting the received advertisement information to a user of at least one of the called and the calling communication device, wherein in response to the call request, the communications provider requests and receives the advertisement information from the advertisement device based on information identifying at least one of the called and the calling communication device and forwards the advertisement information to at least one of called and the calling communication device.

40. The method of claim 39, wherein the advertisement information is stored in the advertisement device and comprise at least one of audio and visual advertisement information.

41. The method of claim 39, further comprising selecting advertisement information based on stored subscriber information.

42. The method of 39, wherein the information identifying the at least one of the called and the calling communication device comprises a phone number associated with the at least one called and calling communication device.

43. The method of claim 41, wherein the subscriber information comprises information relating to capabilities of at least one of the called and the calling communication device.

44. The method of claim 41, wherein the stored subscriber information comprises subscriber demographics.

45. The method of 39, wherein presenting the advertisement information comprises at least one of displaying visual advertisement information to the user; and providing audio advertisement information to the user.

46. The method of 41, wherein the stored subscriber information includes information determined by analyzing subscriber phone usage.

47. The method of 41, further comprising analyzing subscriber information and categorizing subscribers into one or more target audience groups.

48-110. (canceled)
